(19) United States
(12) Patent Application Publication
(10) Pub. No.: US 2007/0003023 A1
(43) Pub. Date: Jan. 4, 2007

(54) System and method for autonomously configuring a reporting network

(76) Inventors: Jerome Rolia, Kanata (CA); Keith I. Farkas, San Carlos, CA (US); Martin F. Arlitt, Calgary (CA); Sven Graupner, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/158,776

(22) Filed: Jun. 22, 2005

(51) Int. Cl. H04M 3/08

(52) U.S. Cl. 379/32.01

(57) ABSTRACT

According to one embodiment of the present invention, a method comprises providing a reporting network for communicating data among parts of a monitoring architecture as desired, wherein the reporting network is dynamically configurable programmatically. The method further comprises maintaining a machine-readable model of the monitoring architecture, and autonomously adapting configuration of the reporting network based on the machine-readable model.

### CROSS-REFERENCE TO RELATED APPLICATIONS

This application is related to concurrently filed and commonly assigned U.S. patent application Ser. Nos. [Attorney Docket No. 200404992-1] entitled “A MODEL-DRIVEN MONITORING ARCHITECTURE”; [Attorney Docket No. 200404994-1] entitled “SYSTEM FOR METRIC INTROSPECTION IN MONITORING SOURCES”; [Attorney Docket No. 200404995-1] entitled “SYSTEM FOR PROGRAMMATICALLY CONTROLLING MEASUREMENTS IN MONITORING SOURCES”; and [Attorney Docket No. 200405195-1] entitled “SYSTEM AND METHOD FOR USING MACHINE-READABLE META-MODELS FOR INTERPRETING DATA MODELS IN A COMPUTING ENVIRONMENT”, the disclosures of which is hereby incorporated herein by reference.

### FIELD OF THE INVENTION

The following description relates in general to monitoring systems, and more particularly to systems and methods for autonomously configuring a reporting network.

### DESCRIPTION OF RELATED ART

Computing systems of various types are widely employed today. Data centers, grid environments, servers, routers, switches, personal computers (PCs), laptop computers, workstations, devices, handhelds, sensors, and various other types of information processing devices are relied upon for performance of tasks. Monitoring systems are also often employed to monitor these computing systems. For instance, monitoring systems may be employed to observe whether a monitored computing system is functioning properly (or at all), the amount of utilization of resources of such monitored computing system (e.g., CPU utilization, memory utilization, I/O utilization, etc.), and/or other aspects of the monitored computing system.

In general, monitoring instrumentation (e.g., software and/or hardware) is often employed at the monitored system to collect information, such as information regarding utilization of its resources, etc. The collected information, which may be referred to as “raw metric data,” may be stored to a data store (e.g., database or other suitable data structure) that is either local to or remote from the monitored computing system, and monitoring tools may then access the stored information. The monitoring data may be pushed to a monitoring tool and/or a monitoring tool may request (or “pull”) the monitoring data from a monitoring source. In some instances, tasks may be triggered by the monitoring tools based on the monitoring data it receives. For example, a monitoring tool may generate utilization charts to display to a user the amount of utilization of resources of a monitored system over a period of time. As another example, alerts may be generated by the monitoring tool to alert a user to a problem with the monitored computing system (e.g., that the computing system is failing to respond). As still another example, the monitoring tool may take action to re-balance workloads among various monitored computing systems (e.g., nodes of a cluster) based on the utilization information observed for each monitored computing system.

Today, monitoring data is collected in the form of metrics that are defined and observed for a monitored computing system. In general, instrumentation and/or monitoring sources are typically configured to collect and/or report various metrics for a given monitored computing system. An example of an existing monitoring architecture is as supported by Hewlett-Packard's OpenView Reporter product. As described further below, such traditional monitoring architectures require manual configuration for monitoring a monitored environment, and changes in the monitoring architecture require manual re-configuration. For instance, changes that have traditionally required manual re-configuration of the monitoring environment (i.e., monitoring infrastructure) include adding a metric to the set of metrics available for a monitored component, and moving an application from one virtualization abstraction to another (e.g., a virtual machine to a virtual partition, wherein metric names change), as examples. As a further example, system activity reporter, which is available on Linux as part of the sysstat collection of performance tools, has changed file formats a number of times, and as a result the “delivery” fails when the collectors are upgraded, as the delivery infrastructure can no longer read the files.

In general, traditional monitoring systems provide data collection agents that interact with instrumentation systems. These agents typically provide for the movement of monitoring data to statically configured monitoring data repositories that pre-suppose the identity of metrics and the topology and configuration of the monitored environment. Data consumer applications (or “monitoring tools”) become coupled with such repositories. That is, a monitoring tool communicatively accesses the repositories (or “monitoring data stores”) of a monitoring source to receive desired monitoring data. The monitoring data repositories typically have schemas that pre-suppose the metrics to be reported and detailed information about the monitored environment. The schemas do not tolerate changes in infrastructure, but rather they must be maintained by a user to support such changes. In turn, data consumer applications (“monitoring tools”) must also be maintained by users to support the changes. For example, if one instrumentation system coupled to a monitored component within a monitoring system is replaced with another instrumentation system that reports similar metrics for the monitored component but with different names for such metrics, traditionally this requires administrative maintenance for data repositories and data consumer applications. That is, a user must manually reconfigure the monitoring source's data repositories and/or consumer applications (monitoring tools) to recognize the new names of the metrics collected by the new instrumentation system. As another example, the new instrumentation system may collect different metrics. For instance, a first instrumentation system may collect data for a “memory utilization” metric as a percentage of utilization of the monitored component's memory, while a second instrumentation system may collect data for the “memory utilization” metric in different units, such as in Kbytes used. As still another example, the new instrumentation system may collect measurements with different frequency, e.g., 60 second intervals instead of 5 minute intervals. Thus, traditionally a user is required to manually reconfigure various elements of the monitoring environment, such as data stores in monitoring sources and/or monitoring tools, to account for any changes made in the instrumentation of the monitored environment.

Further, reporting networks that are used to forward monitoring data from a monitored component to a data consumer (monitoring tool) in traditional monitoring systems are not sensitive to the behavior or configuration of the underlying infrastructure of the monitored environment nor are tailored to the data needs of the data consumers. For example, a network link may have a dynamically varying capacity (which at times may be 0) or may be subject to significantly different loads at various times, and the reporting networks of traditional monitoring systems are not sensitive to the impact of monitoring on the environments being monitored. So, the communication of monitoring data may negatively impact the performance of the underlying monitored environment. For instance, the reporting network may consume valuable bandwidth during a time in which such bandwidth is desperately needed for the underlying monitored environment. Furthermore, some monitoring data may be of greater value than other data. When network resources for monitoring are limited it may be that less valuable data is sent before more valuable data. As another example, reporting networks of traditional monitoring systems do not adapt to changes in the data needs of a data consumer. Because the reporting network is not sensitive to the data needs, it cannot adapt to ensure that the data liveness requirements are met, thus possibly communicating data to the consumer with excessive delays. Users may manually re-configure the reporting networks in response to changes in the monitoring system (e.g., if a monitoring component is replaced), changes in the monitored environment (e.g., if monitored components migrate, etc.), changes in the data needs of the data consumers (e.g., if more fine grain data is required), and changes in the condition of the underlying network.

Thus, traditional monitoring solutions have required manual reconfiguration of the monitoring environment responsive to changes in the monitored environment. In many monitored environments, changes occur relatively seldom and thus such a manual reconfiguration may not be overly burdensome, although often still undesirable. However, many monitoring environments encounter changes much more often. Further, these changes are increasingly difficult due to the increasing complexity of monitored environments and, thus, the monitoring environment. For instance, in a data center environment, applications (and/or other monitored components) may dynamically move from one data center to another (e.g., for load-balancing purposes, etc.). Accordingly, traditional monitoring infrastructures that require such manual reconfiguration (e.g., of the reporting networks) responsive to changes in the underlying monitored environment are undesirably inefficient and inflexible. Further, manual reconfiguration is undesirable because the changes may occur more frequently than humans can react to them, and the need for reconfiguration may not be noticed until the data is needed, at which time the data may have been lost (i.e., data collection may have stopped from the time the change occurred until the time the problem requiring data for diagnosis).

### BRIEF DESCRIPTION OF THE DRAWINGS

FIG. 1 shows an exemplary reporting network according to an embodiment of the present invention;

FIG. 2 shows an exemplary operational flow diagram of an embodiment of the present invention; and

FIG. 3 shows an exemplary system that implements a monitoring architecture and a dynamically programmable reporting network in accordance with an embodiment of the present invention.

### DETAILED DESCRIPTION

Embodiments of the present invention provide a dynamically programmable reporting network. The reporting network may be used for communicating data (e.g., monitored data collected for monitored components, configuration and control information, and contextually classifying meta-data) among the various elements of the monitoring environment and to the data consumers. For instance, the reporting network comprises data source(s), data sink(s), and data pipes. According to embodiments of the present invention, the data source(s), data sink(s), and data pipes are each dynamically programmable (e.g., dynamically re-configurable) and offer value added processing, such as the derivation of new metrics from other metrics, the correlation of metrics, and the filtering of data. The dynamic re-configuration of the data source(s), data sink(s), and data pipes and the customization of the value-added processing they provide are driven by computer instructions which may, for example, be supplied by the monitoring environment such as by the reporting network controller.

Further, embodiments of the present invention provide a model-driven reporting network. For instance, in certain embodiments, a model of the monitoring environment is maintained, and the monitoring environment autonomously adapts its reporting network using the model. That is, in certain embodiments a monitoring model maintains information, such as the topology of the monitoring environment and the data desires of data consumers (e.g., optimize the on-time delivery of specific monitoring data) and the behavioral desires and objectives for the reporting network (e.g., minimize wide area network link utilization for monitoring data) that may be of relevance to administrative personnel. The reporting network is dynamically re-configured (via computer instructions communicated to the programmable parts of the network, such as the data sources, data sinks, and/or data pipes) in response to changes in the monitoring model. Such re-configuration of the reporting network may be performed autonomously by the monitoring system (e.g., by a controller) based on the monitoring model, thus alleviating the burden of manual re-configuration.

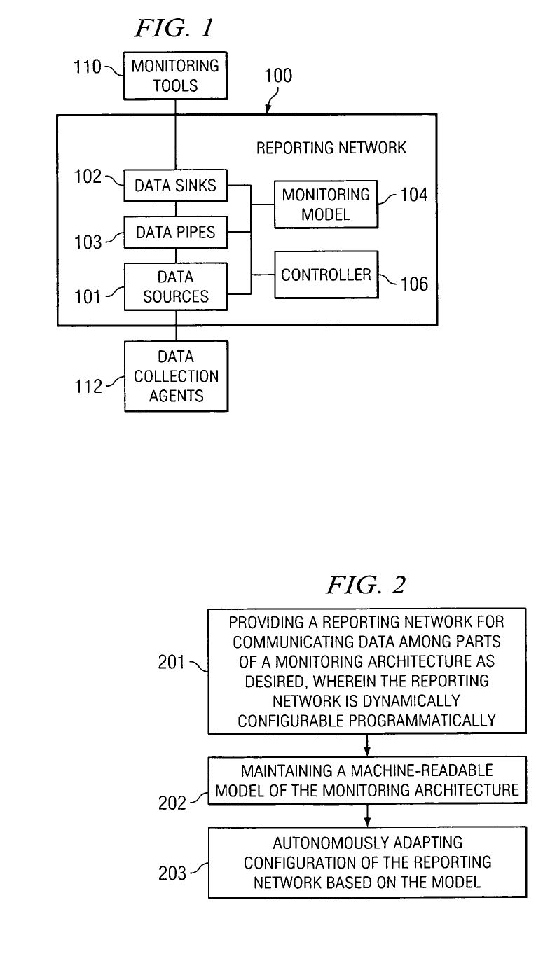

Turning to FIG. 1, an exemplary reporting network 100 according to an embodiment of the present invention is shown. Reporting network 100 comprises data sources 101 and data sinks 102, which are communicatively coupled to the data pipes 103. These three components convey monitoring data from the data collection agents 112 to the monitoring tools (or other data consumers) 110. In addition, in certain embodiments, data sources 101 and data pipes 103 may convey configuration and control information to the data collection agents 112 and the controller 106, and may convey metric model, meta-model and contextually classifying meta-data from data collection agents 112 or other monitoring sources to the monitoring model 104.

The data sources 101, data sinks 102, and data pipes 103 are dynamically programmable (i.e., can be re-configured via computer instructions communicated thereto) by the controller 106. Reporting network 100 may be considered as an “overlay” network, which overlays a monitoring environment. That is, such overlay network may be used for communicating data between various components/devices of a monitoring environment. Exemplary reporting network 100 further includes a monitoring model 104, which maintains a model of the underlying monitoring architecture. Further, based on the monitoring model 104, the reporting network 100 autonomously adapts to changes in the underlying monitoring architecture, changing network conditions, and changing aggregate data needs of the data consumers. As described further herein, reporting network 100 provides continuous data delivery and processing service for dynamically evolving monitored environments. The underlying monitoring components may dynamically evolve in that their configuration and/or behavior changes.

An exemplary operational flow diagram of an embodiment of the present invention is shown in FIG. 2. In operational block 201, a reporting network is provided for communicating data among parts of a monitoring architecture as desired, wherein the reporting network is dynamically configurable programmatically. In operational block 202, a machine-readable model of the monitoring architecture is maintained. That is, as changes occur in the underlying monitoring architecture, machine-readable information (contained in a monitoring services model 104) is updated to accurately reflect the configuration of such monitoring architecture. In operational block 203, the configuration of the reporting network is autonomously adapted based on the model. Operation of embodiments of the present invention is described further in the examples below.

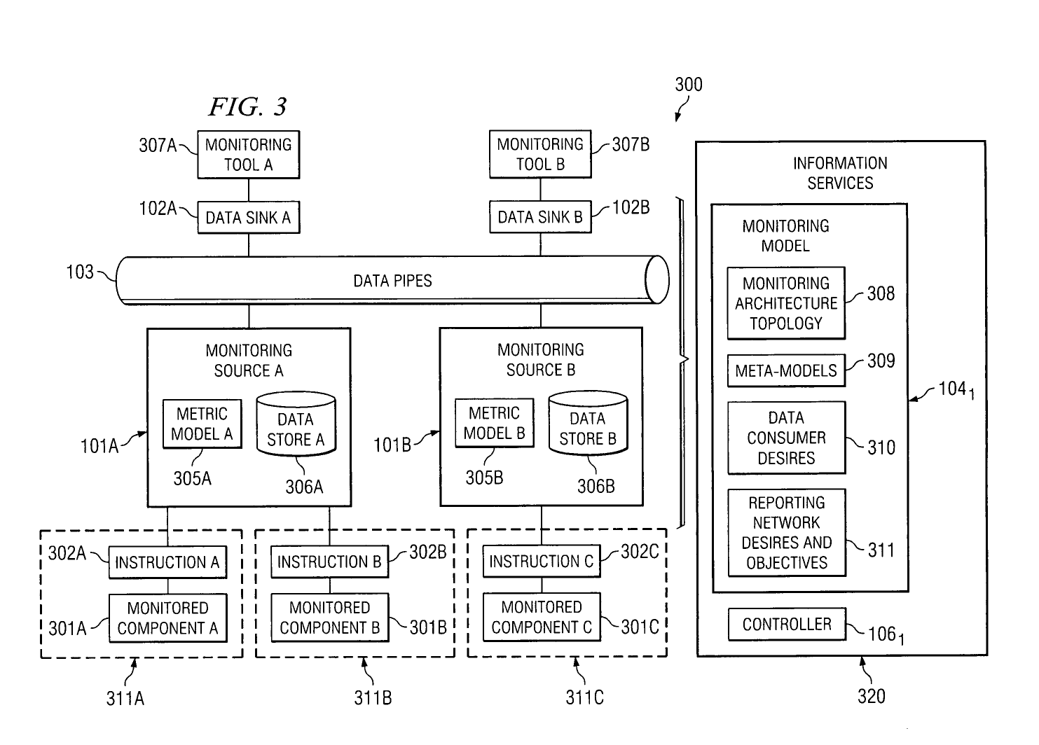

FIG. 3 shows an exemplary system 300 that implements a monitoring environment, including a dynamically programmable reporting network in accordance with an embodiment of the present invention. System 300 comprises monitored environments 311A-311C (referred to collectively as monitored environments 311) that in turn comprise monitored components 301A-301C (referred to collectively as monitored components 301), respectively. Monitored components 301A-301C have associated therewith monitoring instrumentation 302A-302C (referred to collectively as monitoring instrumentation 302), respectively, for collecting monitoring data. For instance, as is well-known in the art, monitoring instrumentation 302 may comprise hardware and/or software for collecting information about a corresponding monitored component 301, which may also be referred to herein as a “monitored computing system.” Each monitored component 301 may comprise any type of monitored computing system, such as a data center, grid environment, server, router, switch, personal computer (PC), laptop computer, workstation, devices, handhelds, sensors, or any other information processing device or application executing on such device. While three monitored components 301 and associated monitoring instrumentation 302 are shown in the exemplary system 300, embodiments of the present invention may be employed for any number of monitored components and monitoring instrumentation.

System 300 further includes monitoring sources 1010A and 101B (referred to collectively as monitoring sources 101), which are further described in the exemplary embodiments of co-pending U.S. patent application Ser. No. [Attorney Docket 200404995-1] titled “SYSTEM FOR PROGRAMMATICALLY CONTROLLING MEASUREMENTS IN MONITORING SOURCES”. A monitoring source 101 is a component that gathers or stores monitoring data about monitored components, such as monitored components 301, in an environment. Monitoring sources commonly include a monitoring data store for storing monitoring data collected for monitored component(s) 301 and may act as data sources in a reporting network. In the example of FIG. 3, monitoring source 101A includes data store 306A for storing monitoring data collected for monitored components 301A-301B; and monitoring source 101B includes data store 306 B for storing monitoring data collected for monitored component 301C. Data stores 306A-306B are referred to collectively as data stores 306. Such data stores 306 may each comprise any suitable form of computer-readable storage medium, such as memory (e.g., RAM), a hard drive, optical disk, floppy disk, tape drive, etc., and may each store their respective monitoring data in the form of a database or any other suitable data structure. In certain implementations, a given monitoring data store 306 may store monitoring data for a plurality of different monitored components 301. The monitoring data stored therein may comprise any number of metrics collected for monitored component(s) 301, such as CPU utilization, memory utilization, I/O utilization, etc. with each of the metrics destined for one more monitoring tools. Monitoring sources 101, data pipes 103, and data sinks 102, in certain embodiments, are components of the reporting services offered by the monitoring environment, as further described in the exemplary embodiments of co-pending U.S. patent application Ser. No. [Attorney Docket 200404992-1] titled “A MODEL-DRIVEN MONITORING ARCHITECTURE”.

Monitoring tools (or “data consumers”) 307A-307B (referred to collectively as monitoring tools 307) are further implemented in system 300, which are each operable to access (e.g., via a communication network) the collected monitoring data in one or more of monitoring data stores 306. As used herein, a “monitoring tool” refers to any device that is operable to access the collected monitoring data for at least one monitored component 301. A monitoring tool 307 may comprise a server, PC, laptop, or other suitable information processing device, which may have one or more software applications executing thereon for accessing the monitoring data in monitoring data stores 306 for one or more monitored components 301. A monitoring tool 307 may be implemented to pull (e.g., request) monitoring data from one or more monitoring sources 101 and/or monitoring tool 307 may, in some instances, receive monitoring data that is pushed from one or more monitoring sources 101 to such monitoring tool 307. Monitoring tools 307 may be implemented, for example, to take responsive actions based on the received monitoring data. Finally, in some embodiments, a monitoring tool has data it makes available to other monitoring tools via a data collector and/or monitoring source so that other monitoring tools can access them via the reporting network

In the exemplary system of FIG. 3, monitoring sources 101A and 101B further include machine-readable metric and context models 305A-305B (referred to collectively herein as monitoring models 305), respectively. Monitoring models 305 specify the monitoring data that is available via their respective monitoring sources 101, and the meta data that described the relationships between the data and the monitored environment. As described further in co-pending U.S. patent application Ser. No. [Attorney Docket 200405195-1] titled “SYSTEM AND METHOD FOR USING MACHINE-READABLE META-MODELS FOR INTERPRETING DATA MODELS IN A COMPUTING ENVIRONMENT”, metric models 305 define the monitoring data stored at the monitoring sources 306. Thus, in certain embodiments, the monitoring data stored to monitoring data store 306A is configured in accordance with metric model 305A; and the monitoring data stored to monitoring data store 306B is configured in accordance with metric model 305B. In general, each monitoring source 101 may include metric models 305 for many monitored components 301.

A reporting network is implemented for use in communicating data between various elements of the above-described monitoring architecture, such as communicating monitored data between monitoring sources 101 and monitoring tools 307, or communicating configuration and control information from information services 320 to monitoring data sources 101, or metric model, meta-model, and contextually classifying meta-data from instrumentation 302 or monitoring sources 101 to the monitoring model 104₁ of information services 320. As described with FIG. 1, such a reporting network comprises data sources (shown in the example of FIG. 3 as monitoring data sources 101A-101B, data sinks (shown in the example of FIG. 3 as data sinks 102A-102B), and data pipes 103. The data sinks 102 are responsible for interfacing the data pipes 103 to the monitoring tools 307. The data sinks 102 also provide additional functionality including being programmable to cache the data to be delivered to a monitoring tool 307 until the tool desires it, to convert the data into a format expected by the monitoring tools 307 and to filter the data to reduce the amount of data that is communicated to the monitoring tool. The data pipes 103 can be similarly programmed to provide similar functionality, including data caching, filtering to limit the rate at which data is transferred between monitoring sources 101 and monitoring tools 307. They may also be provided with policies that they autonomously apply to reconfigure themselves to ensure changing network conditions do not violate network objectives.

The data pipes 103, data sources 101, and data sinks 102 can be implemented as an overlap network, that is, where the functionality they provide by the components of the underlying physical network, such as the computer systems and network routers that constitute an Ethernet-based network. The reporting network may implement the data transport as a multi-cast network, point-to-point network, or other suitable networking configuration using a networking infrastructure such as the Internet or other wide-area network (WAN), a local area network (LAN), a telephony network, a wireless network, or any other networking infrastructure that enables two or more information processing devices to communicate data.

Monitoring model 104, is further included in system 300, which may be accessible by each of the monitoring tools and/or other components in the architecture. Monitoring model 104, models the underlying monitoring infrastructure and can thus be used to autonomously re-configure the reporting network based on changes occurring in the underlying monitoring infrastructure, state of the networking infrastructure, or needs of the monitoring tools 307. For instance, in this example, monitoring model 104, maintains machine-readable information 308 describing the topology of the underlying monitoring architecture and machine-readable information 310 describing the monitoring data desired by data consumers, such as monitoring tools 307. As described further in co-pending U.S. patent application Ser. No. [Attorney Docket No. 200404992-1] titled “A MODEL-DRIVEN MONITORING ARCHITECTURE”, the monitoring model 104, comprises information, some of which is obtained from or derived from monitoring models 305 in system 300. For example, the meta-data contained in metric model 305A from which the relationship between component 301A and its metric can be inferred, may, in certain embodiments, be also included in monitoring model 104. As described further herein, one or more of data sources 101, data pipes 103, and data sinks 102 may be programmatically re-configured based on the machine-readable information maintained in monitoring services model 104₁ to both provide data desired by monitoring tools 307 and to achieve the desires and objectives for the reporting services network 311.

Further, in the exemplary system of FIG. 3, one or more machine-readable metric meta-models 309 are also included in monitoring model 104₁ provided, which define the structure (e.g., syntax) used by corresponding metric models 305, as described further in co-pending U.S. patent application Ser. No. [Attorney Docket No. 200405195-1] titled “SYSTEM AND METHOD FOR USING MACHINE-READABLE META-MODELS FOR INTERPRETING DATA MODELS IN A COMPUTING ENVIRONMENT”. As such, a monitoring tool 307 can access metric meta-models 309 and thus determine the structure of the corresponding metric model(s) 305. Further, the monitoring tools 307 can dynamically adapt and understand the monitoring data of different monitoring sources 101 which are structured according to different metric models 305 (by accessing the corresponding machine-readable meta-model 309 on which each metric model 305 is based), rather than monitoring tool 307 being required to be manually hard-coded to recognize the structure of each metric model 305.

When changes occur in the configuration of the monitoring architecture, the monitoring model 104₁ is modified to enable components within the monitoring system including the reporting network to autonomously adapt to the changes without requiring a user to manually re-configure those components. For instance, as the configuration of the monitoring system changes over time, such as the metric model of a monitoring source and/or a relationship between a data consumer and monitoring source changing, the monitoring model 104₁ is informed via an event and it updates its machine-readable information to reflect these configuration changes. When changes occur that affect elements of the monitoring environment, such as the monitoring tools 307, monitoring sources 101, etc., the elements are informed via an event that a change has taken place. The elements can subsequently access the monitoring model 104₁ (which may be part of an “information service” as shown in FIG. 3) in response to the change to autonomously determine, based on the machine readable information maintained in the monitoring services model, changes occurring in the configuration of the monitoring environment and adapt thereto.

Further, the reporting network can be autonomously re-configured programmatically (i.e., using computer instructions communicated thereto) based on the monitoring model. As elements of the monitoring environment make changes to their information requirements or as the data requirements of the monitoring tools change, the monitoring system controller (such as controller 106, in FIG. 3) re-evaluates the requirements on monitoring sources and uses the control interfaces for the monitoring sources to command the collection of the desired information. It also uses the control interfaces of the data sources, data pipes, and data sinks to make desired changes to the reporting network.

Consider the following example of such a change. The monitoring tool 307A may require access to the component 301A's metric with type CPU Utilization. Yet, the component may be migrated at any time from its association with monitoring source 101A to an association with a second monitoring source, say, monitoring source 101B. When such a migration occurs, the monitored component informs the monitoring source 101A that it is being moved, and hence, that source will no longer be the source for its monitoring data. The monitoring source 101A thus informs the information service 320 that the monitoring model 104, must be changed to reflect this change. Shortly thereafter, the component is migrated to monitoring source 101B, and informs monitoring source 101B that is now the source of the metrics for component 301A.

In one embodiment, these migration events are forwarded to the monitoring tool 307A that desires data for the component 301A's CPU metric, respectively. Using metric and context models, the monitoring tool discovers that the second monitoring source 101B supports a metric with the type CPU_Utilization and its corresponding metric's name. The monitoring tool 307A may then update the monitoring model to indicate that it desires monitoring data for the component from monitoring source 101B rather than 101A using the metric name that is understood by the second source along with information that includes other requirements such as reporting latency and reporting frequency. The information services control 1061 may then command the monitoring source 101B to collect that data according to these requirements and make it available via data source 101B to the reporting network. In another embodiment, the controller 106₁, using the context model and metric models, recognizes that the data that tool 307A desires is now provided by monitoring source 101B, and accordingly programs the reporting network and monitoring source 101B to begin delivering the desired data to data sink 102A. As such, in this embodiment, the monitoring tool 307A is neither made aware that a change has occurred nor must take any steps to retain connectivity to the data it desires.

The changes resulting from the migration, which have been reflected in the monitoring model 104₁, may impact the desired implementation of the reporting network. Changes may, for example, impact data volumes or expectations on reporting latency for the reporting network. If changes to the reporting network are desirable to better meet the desires and objectives of the network 311, then the information services controller 106₁ programs the data sources, data pipes, and data sinks to reconfigure to achieve the objectives of the reporting network.

As one example of this reconfiguration, a uni-cast overlay network may be rendered that provides separate data flows from each monitoring source to each monitoring tool that desires data from the source. The separate data flows may support differing requirements for reporting latency. In another example, a multi-cast overlay network is rendered that only passes identical once over any network segment on its route to one or more monitoring tools. Such overlay networks exist within the data sources, data pipes, and data sinks so that value added service can still be provided. However, network control services from supporting networks that support uni-cast, multi-cast, or other delivery approaches may be employed. The choice of how to configure the reporting network is based on desires and objectives for the reporting network 311. The choice may serve to minimize the use of bandwidth for certain network links, to support latency or other quality of service requirements, to amortize reporting network infrastructure by exploiting already deployed data pipe or sink elements, or other objectives. The algorithms that decide which network infrastructure to induce (e.g., uni-cast, multi-cast) rely upon graph manipulation algorithms from telecommunication network traffic engineering theory (e.g., shortest path, widest path, quality of service based routing, optimization) that are well known to those with ordinary skill in this art to best achieve the desired objectives of reporting network. Once a choice is identified, a set of previously defined policies and activation templates can be applied by the information services controller 106₁ to effect the change. In an alternative embodiment, the information services controller 106₁ may also rely on policies and activation templates that are internal to the monitoring sources. Techniques of policy driven automation are well known to those skilled in the art of policy driven automation.

The monitoring infrastructure controller, such as the information services controller 106₁ in FIG. 3, exploits mechanisms in the general programmable environment to deploy, start and terminate the data sources, data pipes, and data sinks throughout a monitored environment in a manner well known to those with ordinary skills in the art of distributed application and service deployment. The controller may exploit alternative deployment locations that are specified in the monitoring model 104₁ by system administrators. The specification may change over time causing the monitoring environment controller 106₁ to re-evaluate the implementation of reporting network. Data sources, data pipes and data sinks have programmatic interfaces that enable the construction and maintenance of reporting networks by the monitoring environment controller 106₁ The programmatic interfaces on the data sources, data pipes, and data sinks enable the creation and termination of zero or more point-to-point data flows between pairs of monitoring sources, data sources, data pipes, data sinks, and/or monitoring tools. In this way, arbitrary reporting networks may be constructed from the monitoring sources, data sources, data pipes, data sinks and monitoring tools.

Point-to-point connections are specified using identities of endpoints that are supported by the underlying networking technology (e.g., Internet Protocol Address, Universal Resource Locator). Furthermore, the programmatic interface enables the registration of model information for metrics that are supported so that data may be interpreted, stored, and forwarded by the data sources, data pipes, and data sinks, so that it may be specified how metric data is routed through the data flows to arrive at the appropriate data sinks for the monitoring tools, so that value added services may be applied to the data (e.g., conversion from one measurement unit to another to prioritize data for different monitoring data consumers or tools (e.g., administrators may have priority over regular monitoring tool users, audit functions priority over administrators, system utilization data over transaction logs, system utilization data at 5 minute intervals over system utilization data at one minute intervals, etc.)), and so that reporting requirements (e.g., latency, how long to hold data before discarding if the data cannot be forwarded) can be applied to data as required. On one embodiment, value added services are applied at the earliest opportunity in the reporting network. In one embodiment, metric data for two tools with different reporting frequency requirements are treated as two separate demands on the monitoring source and with two separate specifications for data routing via the monitoring services network. In one embodiment, transport protocols are used that guarantee the delivery of data for one or more data flows. In one embodiment, transport protocols are used that guarantee the delivery of data for one or more data flows. In one embodiment, transport protocols that require the explicit acknowledgement of data received data are used to implement one or more data flows.

Finally, the reporting network may employ monitoring tools to support its understanding of its own behavior. In that way it may also act as a data consumer. It may use the monitored data to decide how and when to implement value added services such as deciding when to drop lower priority data, or as part of the subscription process for deciding whether an additional request for a data flow can be supported without a reporting network re-configuration.

What is claimed is:

1. A method comprising:
providing a reporting network for communicating data among parts of a monitoring architecture as desired, wherein the reporting network is dynamically configurable programmatically;
maintaining a machine-readable model of the monitoring architecture; and
autonomously adapting configuration of the reporting network based on the machine-readable model.

2. The method of claim 1 wherein said autonomously adapting comprises:
a controller programmatically re-configuring said reporting network based on the machine-readable model.

3. The method of claim 1 wherein said maintaining a machine-readable model comprises:
autonomously updating said machine-readable model to reflect a current configuration of said monitoring architecture.

4. The method of claim 1 wherein said machine-readable model of the monitoring architecture comprises information defining at least one of the following:
at least one meta-model that defines a structure of how information is represented in at least one data model;
information defining topology of the monitoring architecture;
information specifying data consumer desires; and
information specifying reporting network desires.

5. The method of claim 1 wherein said communicating data among parts of a monitoring architecture comprises:
communicating at least one of monitored data collected for a monitored component, configuration information for said monitoring architecture, control information, and contextually classifying meta-data.

6. The method of claim 1 wherein said providing said reporting network comprises:
providing data sources, data sinks, and data pipes.

7. The method of claim 6 wherein said data sources, data sinks, and data pipes are programmatically configurable.

8. The method of claim 7 comprising:
programmatically reconfiguring said data pipes for changing a load placed on an underlying physical network.

9. The method of claim 7 comprising:
programmatically configuring at least one of said data sources, data sinks, and data pipes for providing desired value added services.

10. The method of claim 9 wherein said value added services comprises at least one of the following:
deriving new metrics and filtering metrics from monitoring data received for a monitored component.

11. The method of claim 7 comprising:
programmatically configuring at least one of said data sources, data sinks, and data pipes for prioritizing delivery of data to a given monitoring tool.

12. A system comprising:
a machine-readable model of a monitoring architecture; and
a reporting network for communicating data among parts of the monitoring architecture as desired, wherein the reporting network is autonomously configurable programmatically based on said machine-readable model.

13. The system of claim 12 further comprising:
a controller for programmatically configuring said reporting network based on the machine-readable model.

14. The system of claim 12 wherein said machine-readable model is autonomously updated responsive to changes in a monitored environment to reflect a current configuration of said monitoring architecture.

15. The system of claim 12 wherein said machine-readable model of the monitoring architecture comprises information defining at least one of the following:
at least one meta-model that defines a structure of how information is represented in at least one data model;
information defining topology of the monitoring architecture;
information specifying data consumer desires; and
information specifying reporting network desires.

16. The system of claim 12 wherein said reporting network comprises:
data sources, data sinks, and data pipes.

17. The system of claim 16 wherein said data sources, data sinks, and data pipes are programmatically configurable.

18. A system comprising:
a dynamically changing monitored environment comprising at least one monitored component about which monitored data is collected;
a data consumer desiring said monitored data;
a reporting network for communicating said monitored data to said data consumer, wherein said reporting network comprises data sources, data pipes, and data sinks that are programmatically configurable;
a machine-readable monitoring model; and
a controller operable to autonomously programmatically configure ones of said data sources, data pipes, and data sinks based on said machine-readable monitoring model.

19. The system of claim 18 wherein said machine-readable monitoring model defines configuration of a monitoring environment.

20. The system of claim 19 wherein said machine-readable monitoring model is autonomously updated responsive to changes in said monitored environment to reflect a current configuration of said monitoring environment for monitoring the changed monitored environment.

21. The system of claim 20 wherein said machine-readable monitoring model of the monitoring architecture comprises information defining at least one of the following:
at least one meta-model that defines a structure of how information is represented in at least one data model;
information defining topology of the monitoring environment;
information specifying data consumer desires; and
information specifying reporting network desires.
